(19) United States
(12) Patent Application Publication
(10) Pub. No.: US 2026/0056503 A1
(43) Pub. Date: Feb. 26, 2026

(54) IMAGE FORMING SYSTEM

(71) Applicant: FUJIFILM Business Innovation Corp., Tokyo (JP)

(72) Inventor: Shoya KINOSHITA, Kanagawa (JP)

(73) Assignee: FUJIFILM Business Innovation Corp., Tokyo (JP)

(21) Appl. No.: 19/057,593

(22) Filed: Feb. 19, 2025

(30) Foreign Application Priority Data
Aug. 23, 2024 (JP) 2024-143459

(51) Int. Cl. G03G 15/00

(52) U.S. Cl. CPC G03G 15/6573; G03G 15/6582; G03G 2215/00691

(57) ABSTRACT

An image forming system includes: an image forming apparatus that forms an image on a recording medium; a relay transporter that transports the recording medium on which the image is formed by the image forming apparatus; a post-processing apparatus including a collecting container that collects a recording medium, the post-processing apparatus performing post-processing on the recording medium transported by the relay transporter; and at least one processor configured to stop transport of a recording medium when a paper jam occurs in the post-processing apparatus and, if a remaining recording medium is present in the relay transporter when the paper jam is cleared and the transport of the recording medium is restarted, cause the remaining recording medium to be collected by the collecting container.

### CROSS-REFERENCE TO RELATED APPLICATIONS

This application is based on and claims priority under 35 USC 119 from Japanese Patent Application No. 2024-143459 filed Aug. 23, 2024.

### BACKGROUND

### (i) Technical Field

The present disclosure relates to an image forming system.

### (ii) Related Art

An image forming apparatus described in Japanese Unexamined Patent Application Publication No. 2006-094280 includes an automatic document transport unit that automatically and successively transports document sheets to an image reading position, an image forming unit that forms a document image that is read, and a shredder that shreds paper sheets. The automatic document transport unit automatically and successively transports paper sheets placed on the automatic document transport unit to the shredder in response to an instruction from an operation unit of the image forming apparatus.

### SUMMARY

A known image forming system includes an image forming apparatus that forms an image on a recording medium and a post-processing apparatus that performs post-processing on the recording medium on which the image is formed. This image forming system also includes a relay transporter that transports the recording medium from the image forming apparatus to the post-processing apparatus.

In this image forming system, a recording medium transported from the image forming apparatus to the post-processing apparatus through the relay transporter and processed in the post-processing apparatus may cause a paper jam in the post-processing apparatus. When the paper jam occurs, the transport of recording media is stopped. After the paper jam is cleared, the transport of the recording media is restarted.

When the transport of the recording media is restarted after the paper jam is cleared, there may be a recording medium remaining in the relay transporter. In such a case, when the transport of the recording media is restarted, the recording medium that has remained in the relay transporter is subjected to post-processing by the post-processing apparatus and then output from the post-processing apparatus. A stoppage of the transport of a recording medium prior to post-processing may result in the degradation of image quality. Therefore, it is undesirable to output the recording medium that has remained in the relay transporter from the post-processing apparatus.

Aspects of non-limiting embodiments of the present disclosure relate to the prevention of a recording medium that has remained in a relay transporter from being output from a post-processing apparatus when the transport of recording media is restarted after being stopped in response to a paper jam in the post-processing apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming system including: an image forming apparatus that forms an image on a recording medium; a relay transporter that transports the recording medium on which the image is formed by the image forming apparatus; a post-processing apparatus including a collecting container that collects a recording medium, the post-processing apparatus performing post-processing on the recording medium transported by the relay transporter; and at least one processor configured to stop transport of a recording medium when a paper jam occurs in the post-processing apparatus and, if a remaining recording medium is present in the relay transporter when the paper jam is cleared and the transport of the recording medium is restarted, cause the remaining recording medium to be collected by the collecting container.

### BRIEF DESCRIPTION OF THE DRAWINGS

An exemplary embodiment of the present disclosure will be described in detail based on the following figures, wherein:

FIG. 1 is a schematic diagram illustrating the structure of an image forming system according to an exemplary embodiment of the present disclosure;

FIG. 2 is a side view of a post-processing apparatus included in the image forming system according to the exemplary embodiment of the present disclosure;

FIG. 3 is a plan view of the post-processing apparatus included in the image forming system according to the exemplary embodiment of the present disclosure;

FIG. 4 is a side view of a gloss fixing unit of the post-processing apparatus included in the image forming system according to the exemplary embodiment of the present disclosure;

FIGS. 5A and 5B are block diagrams respectively illustrating the hardware configuration and the functional configuration of a controller of the post-processing apparatus according to the exemplary embodiment of the present disclosure; and

FIG. 6 is a flowchart illustrating a procedure performed when a paper jam occurs in the image forming system according to the exemplary embodiment of the present disclosure.

### DETAILED DESCRIPTION

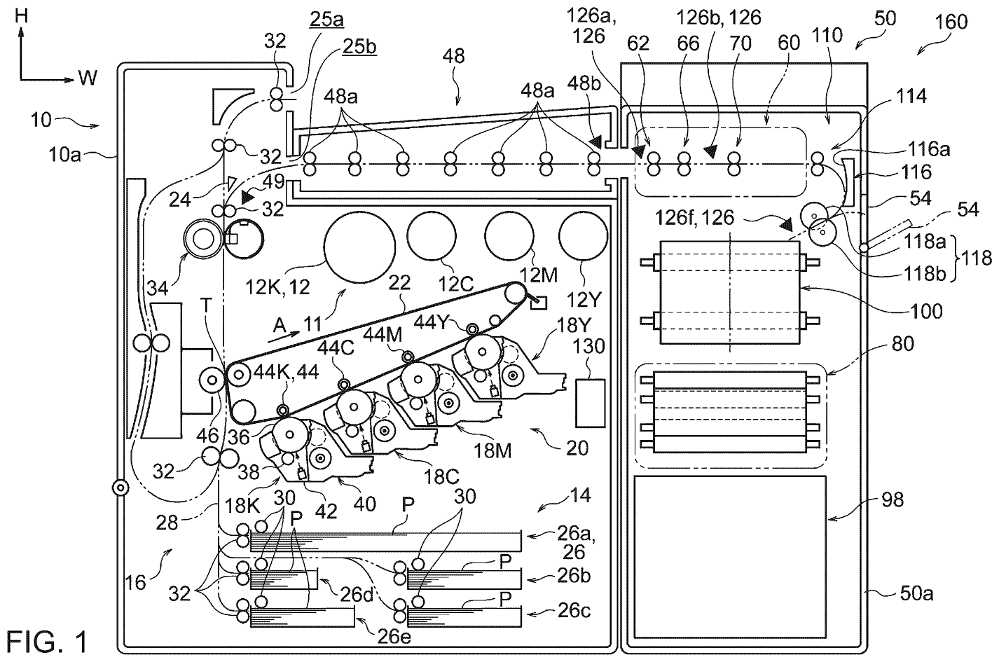

An example of an image forming system according to an exemplary embodiment of the present disclosure will be described with reference to FIGS. 1 to 6. In each figure, arrow H indicates the vertical direction, which is the up-down direction of the system. Arrow W is orthogonal to arrow H and indicates a horizontal direction that is the width direction of the system. Arrow D is orthogonal to arrows H and W and indicates a horizontal direction that is the depth direction of the system.

### Overall Structure of Image Forming System 160

As illustrated in FIG. 1, an image forming system 160 includes an image forming apparatus 10, a post-processing apparatus 50, a relay transporter 48, and a controller 130. The image forming apparatus 10 is an apparatus that forms a toner image on a recording medium P by an electrophotographic system. The post-processing apparatus 50 is a device that removes edge portions of the recording medium P on which the toner image is formed by the image forming apparatus 10 and imparts gloss to the toner image. The post-processing apparatus 50 is a device for forming a photographic print image with no white borders.

The relay transporter 48 is a device that transports the recording medium P on which the toner image is formed by the image forming apparatus 10 toward the post-processing apparatus 50. The relay transporter 48 is placed on an upper portion of the image forming apparatus 10.

The image forming apparatus 10 and the post-processing apparatus 50 are arranged in that order from a first side toward a second side in the width direction. The width direction is the left-right direction as viewed by a user standing in front of the apparatus.

### Image Forming Apparatus 10

As illustrated in FIG. 1, the image forming apparatus 10 includes a medium storage unit 14 that stores recording media P and a transport unit 16 that transports the recording media P stored in the medium storage unit 14. The image forming apparatus 10 also includes an image forming section 20 that forms an image on each recording medium P transported from the medium storage unit 14 by the transport unit 16. The image forming apparatus 10 also includes a toner storage unit 11 that stores toner. The medium storage unit 14, the image forming section 20, and the toner storage unit 11 are arranged in that order from the bottom toward the top.

### Medium Storage Unit 14

As illustrated in FIG. 1, the medium storage unit 14 includes plural storage members 26 capable of being pulled out of an apparatus body 10a of the image forming apparatus 10 toward the near side in the depth direction. The medium storage unit 14 also includes feed rollers 30 that feed the recording media P placed on the storage members 26 toward a transport path 28. In the present exemplary embodiment, five storage members 26a to 26e are provided. The storage members 26d and 26e store photo paper for outputting photographs. The storage members 26a to 26c store plain paper of a standard size, such as A4-size or A3-size.

### Transport Unit 16

As illustrated in FIG. 1, the transport unit 16 includes plural transport rollers 32 that transport the recording media P fed from the storage members 26 by the feed rollers 30 along the transport path 28.

The transport unit 16 also includes a sorting member 24 that sorts each recording medium P output from the apparatus body 10a and a detector 49 that detects the recording medium P. More specifically, the recording medium P sorted by the sorting member 24 is output through an outlet 25a or an outlet 25b below the outlet 25a. The relay transporter 48 receives the recording medium P output through the outlet 25b. The detector 49 is disposed to detect the recording medium P transported toward the relay transporter 48 after the toner image is fixed thereto by a fixing device 34 that fixes the toner image to the recording medium P.

### Image Forming Section 20

As illustrated in FIG. 1, the image forming section 20 includes image forming units 18Y, 18M, 18C, and 18K serving as four units for forming yellow (Y), magenta (M), cyan (C), and black (K) images. In the following description, Y, M, C, and K may be omitted when it is not necessary to distinguish between Y, M, C, and K.

The image forming unit 18 of each color includes an image carrier 36, a charging member 38 that charges a surface of the image carrier 36, and an exposure device 42 that irradiates the image carrier 36 with exposure light. The image forming unit 18 of each color also includes a developing device 40 that develops an electrostatic latent image formed when the exposure device 42 irradiates the charged image carrier 36 with the exposure light.

The image forming section 20 also includes an endless transfer belt 22 that rotates in the direction of arrow A in FIG. 1. The image forming section 20 also includes first transfer rollers 44 that transfer toner images formed by the image forming units 18 of the respective colors to the transfer belt 22. The image forming section 20 also includes a second transfer roller 46 that transfers the toner images transferred to the transfer belt 22 to the recording medium P. The image forming section 20 also includes the fixing device 34 that applies heat and pressure to the recording medium P to which the toner images have been transferred to fix the toner images to the recording medium P.

### Toner Storage Unit 11

As illustrated in FIG. 1, the toner storage unit 11 includes a storage member 12Y that stores yellow (Y) toner and a storage member 12M that stores magenta (M) toner. The toner storage unit 11 also includes a storage member 12C that stores cyan (C) toner and a storage member 12K that stores black (K) toner. The storage members 12K, 12C, 12M, and 12Y are arranged in that order from the first side (left in FIG. 1) to the second side (right in FIG. 1) in the width direction. The storage member 12K that stores black toner, which is used most, has a capacity greater than those of other storage members 12.

### Operation of Image Forming Apparatus

The image forming apparatus 10 forms an image as described below.

First, the charging members 38 of the respective colors are energized to uniformly charge the surfaces of the image carriers 36 of the respective colors to a predetermined negative potential. Subsequently, the exposure devices 42 of the respective colors irradiate the charged surfaces of the image carriers 36 of the respective colors with exposure light based on image data to form electrostatic latent images.

Thus, the electrostatic latent images corresponding to the image data are formed on the surfaces of the image carriers 36 of the respective colors. The developing devices 40 of the respective colors develop and visualize the electrostatic latent images as toner images. The first transfer rollers 44 of the respective colors transfer the toner images formed on the surfaces of the image carriers 36 of the respective colors to the transfer belt 22.

The recording medium P is fed from one of the storage members 26 to the transport path 28 by the corresponding feed roller 30 and transported to a transfer position T at which the transfer belt 22 and the second transfer roller 46 are in contact with each other. The recording medium P is transported between the transfer belt 22 and the second transfer roller 46 at the transfer position T, so that the toner images on the surface of the transfer belt 22 are transferred to the recording medium P.

The toner images transferred to the recording medium P are fixed to the recording medium P by the fixing device 34. Then, the recording medium P to which the toner images are fixed is sorted by the sorting member 24. When the recording medium P is plain paper, the sorting member 24 causes the recording medium P to be output to the outside of the apparatus body 10a through the outlet 25a.

When the recording medium P is photo paper, the sorting member 24 causes the recording medium P to be output through the outlet 25b. The recording medium P output through the outlet 25b is received by the relay transporter 48.

When the toner images formed on the transfer belt 22 are transferred to the recording medium P, edge portions, which are white borders, are provided along the four edges of the recording medium P to prevent the toner from adhering to the second transfer roller 46.

### Relay Transporter 48

The relay transporter 48 is removably attachable to the apparatus body 10a of the image forming apparatus 10. As illustrated in FIG. 1, the relay transporter 48 receives the recording medium P output through the outlet 25b in the image forming apparatus 10 and transports the recording medium P to the post-processing apparatus 50.

More specifically, the relay transporter 48 includes plural transport rollers 48a and a detector 48b. The transport rollers 48a are arranged along the transport path 28 with intervals therebetween. The detector 48b is disposed to detect the recording medium P delivered from the relay transporter 48 to the post-processing apparatus 50.

### Post-Processing Apparatus 50

As illustrated in FIG. 1, the post-processing apparatus 50 includes a cutter 60 and a gloss fixing unit 80. The cutter 60 cuts off the four edge portions of the recording medium P. The gloss fixing unit 80 imparts gloss to the toner image formed on the recording medium P.

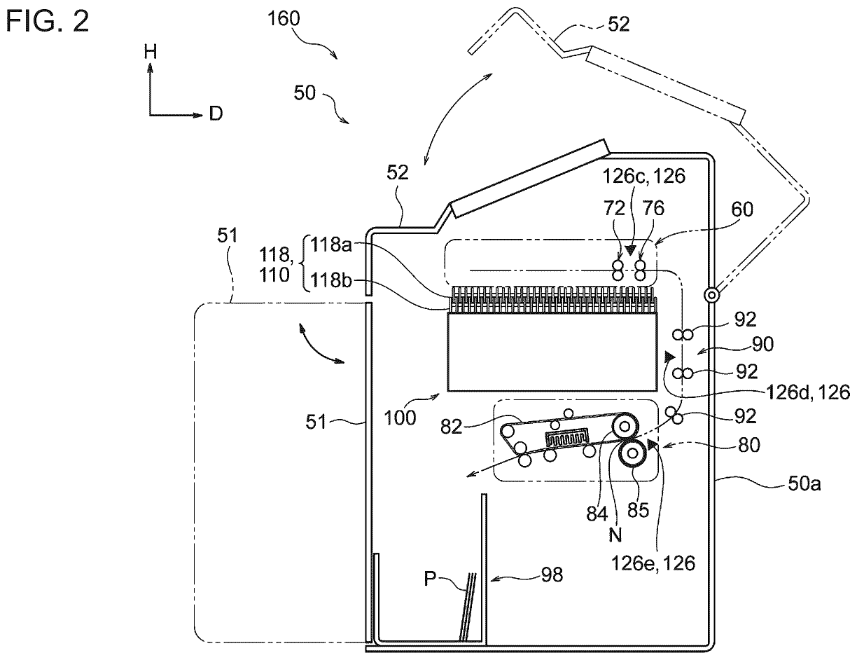

As illustrated in FIGS. 1 and 2, the post-processing apparatus 50 also includes a transport unit 90, a collecting container 100, an output unit 98, and a shredder 110. The transport unit 90 transports the recording medium P. The collecting container 100 collects the edge portions cut off by the cutter 60. The output unit 98 is a unit to which the recording medium P is output. The shredder 110 shreds recording media P with low image quality. These units are disposed in a housing 50a.

The cutter 60, the collecting container 100, the gloss fixing unit 80, and the output unit 98 are arranged in that order from the top toward the bottom in the up-down direction. The shredder 110 is disposed above the collecting container 100 in the up-down direction and on the second side of the cutter 60 and the collecting container 100 in the width direction.

As illustrated in FIG. 2, the transport unit 90 is disposed behind the cutter 60, the collecting container 100, and the gloss fixing unit 80 in the depth direction. The output unit 98 is disposed in front of the gloss fixing unit 80 in the depth direction. Here, the depth direction is the depth direction as viewed from the user standing in front of the apparatus.

### Cutter 60

As illustrated in FIG. 1, the cutter 60 is disposed to receive the recording medium P on which the toner image is formed and that is transported by the relay transporter 48 at the first side of the cutter 60 in the width direction.

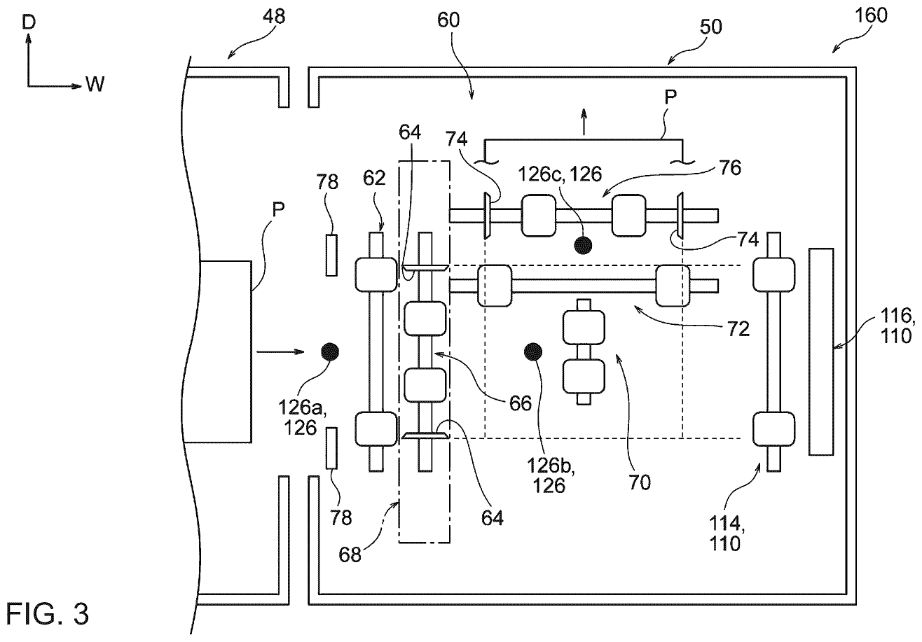

As illustrated in FIG. 3, the cutter 60 includes a transport roller 62 that receives the recording medium P transported in the width direction from the relay transporter 48 without changing the direction in which the recording medium P is transported (hereinafter referred to as a “medium transport direction”). The cutter 60 also includes a pair of first cutters 64 that rotate while cutting the edge portions of the recording medium P transported by the transport roller 62. The cutter 60 also includes a transport roller 66 that includes a shaft to which the first cutters 64 are attached and applies a transport force in the width direction to the recording medium P having the edge portions being cut off.

The cutter 60 also includes an adjustment mechanism 68 capable of moving the first cutters 64 and the transport roller 66 together in an axial direction to adjust the cutting positions.

A transport roller 70 is disposed downstream of the adjustment mechanism 68 in the medium transport direction. The transport roller 70 transports the recording medium P whose edge portions have been cut off by the first cutters 64 in the width direction and positions the recording medium P in the width direction. The transport roller 70 is in contact with the recording medium P when the recording medium P is transported in the width direction and is separated from the recording medium P when the recording medium P is transported toward the far side in the depth direction.

The cutter 60 also includes a transport roller 72 that transports the recording medium P toward the far side in the depth direction. The cutter 60 also includes a pair of second cutters 74 that rotate while cutting the edge portions of the recording medium P transported toward the far side in the depth direction by the transport roller 72.

The cutter 60 also includes a transport roller 76 that includes a shaft to which the second cutters 74 are attached and applies a transport force in the depth direction to the recording medium P having the edge portions being cut off. The transport roller 72 is separated from the recording medium P when the recording medium P is transported in the width direction and is in contact with the recording medium P when the recording medium P is transported toward the far side in the depth direction.

To adjust the cutting positions, edge portions of the fixed image to be cut are detected by cutting-position detection sensors 78 disposed upstream of the transport roller 62 in the medium transport direction. The cutting-position detection sensors 78 are disposed at an IN side (front of the apparatus) and an OUT side (back of the apparatus) at which image/non-image regions can be determined before the recording medium P enters the cutting mechanism.

In this structure, the transport roller 62, the transport roller 66, and the transport roller 70 illustrated in FIG. 3 transport the recording medium P supplied from the relay transporter 48 from the first side toward the second side in the width direction. The first cutters 64 cut off the edge portions of the recording medium P that is transported, and the edge portions that have been cut off are guided by a guide (not illustrated) and collected by the collecting container 100 (see FIG. 2).

The transport roller 72 and the transport roller 76 transport the recording medium P toward the far side in the depth direction. The second cutters 74 cut off the edge portions of the recording medium P that is transported, and the edge portions that have been cut off are guided by a guide (not illustrated) and collected by the collecting container 100 (see FIG. 2).

As illustrated in FIG. 2, the housing 50a of the post-processing apparatus 50 includes a maintenance door 52 that opens at the top of the cutter 60. When, for example, a paper jam occurs in the cutter 60, the maintenance door 52 is opened to expose the cutter 60 to the outside. Then, the recording medium P that has caused the paper jam is removed.

### Collecting Container 100

The collecting container 100 has the shape of a box with an open top. As illustrated in FIGS. 1 and 2, the collecting container 100 is disposed below the cutter 60 and above the gloss fixing unit 80.

As illustrated in FIG. 2, the housing 50a of the post-processing apparatus 50 includes a maintenance door 51 that opens to expose the inside of the post-processing apparatus 50 at the front of the housing 50a in the depth direction. When the maintenance door 51 is opened to expose the inside of the housing 50a, the collecting container 100 is removably attachable to the housing 50a from the front of the housing 50a in the depth direction.

### Shredder 110

As illustrated in FIG. 1, the shredder 110 is disposed above the collecting container 100 in the up-down direction and on the second side of the cutter 60 and the collecting container 100 in the width direction.

The shredder 110 includes a transport roller 114, a guide member 116, and a shredding blade section 118. The transport roller 114 transports the recording medium P transported by the transport roller 70 in the width direction without changing the medium transport direction. The guide member 116 changes the medium transport direction of the recording medium P transported by the transport roller 114. The shredding blade section 118 shreds the recording medium P guided by the guide member 116.

The transport roller 114 is disposed on the second side of the transport roller 70 in the width direction, and the axial direction of the transport roller 114 is the depth direction. The guide member 116 is disposed on the second side of the transport roller 114 in the width direction. The guide member 116 has a guide surface 116a that is a concave surface facing the transport roller 114.

The shredding blade section 118 is disposed on first side of the guide member 116 in the width direction to receive the recording medium P guided along the guide surface 116a. As illustrated in FIGS. 1 and 2, the shredding blade section 118 includes a blade unit 118a including plural disc-shaped blades. The shredding blade section 118 also includes a blade unit 118b including plural disc-shaped blades that partially mesh with the blades of the blade unit 118a. The axial direction of the blade units 118a and 118b is the depth direction.

In this structure, the blade units 118a and 118b rotate and transport the recording medium P while shredding the recording medium P. The shreds of the recording medium P are collected by the collecting container 100.

As illustrated in FIG. 1, the housing 50a has an opening door 54 that opens to expose the shredder 110 to the outside. When the opening door 54 is open (two-dot chain line in FIG. 1), the recording medium P can be fed into the housing 50a from the outside and shredded by the shredder 110. In the present exemplary embodiment, when the opening door 54 is open, the shredding blade section 118 in a non-operating state is activated. The opening door 54 is an example of an opening part.

### Transport Unit 90

As illustrated in FIG. 2, the transport unit 90 is disposed behind the collecting container 100 in the depth direction. The transport unit 90 includes plural transport rollers 92 that receive the recording medium P fed from the cutter 60 and transport the recording medium P toward the gloss fixing unit 80. The axial direction of the plural transport rollers 92 is the width direction, and the plural transport rollers 92 are disposed behind the collecting container 100 in the depth direction.

When, for example, a paper jam occurs in the transport unit 90, the maintenance door 51 is opened to expose the inside of the housing 50a, and the collecting container 100 is removed from the housing 50a. In this state, the recording medium P that has caused the paper jam is removed from the transport unit 90. In the present exemplary embodiment, a paper jam refers to a situation in which the recording medium P being transported stops at an unexpected position.

The transport unit 90 also includes plural detectors 126 that detect the recording medium P that is transported. As illustrated in FIG. 3, a detector 126a, a detector 126b, and a detector 126c are arranged from an upstream side in the medium transport direction. As illustrated in FIG. 2, a detector 126d and a detector 126e are arranged from the upstream side in the medium transport direction.

More specifically, the detector 126a illustrated in FIG. 3 is disposed upstream of the transport roller 62 in the medium transport direction. The detector 126b is disposed between the transport roller 66 and the transport roller 70 in the medium transport direction. The detector 126c is disposed between the transport roller 72 and the transport roller 76 in the medium transport direction. The detector 126d illustrated in FIG. 2 is disposed to detect the recording medium P transported downward by the transport rollers 92. The detector 126e is disposed to detect the recording medium P that enters the gloss fixing unit 80.

As illustrated in FIG. 1, the transport unit 90 also includes a detector 126f. The detector 126f is disposed to detect the recording medium P shredded by the shredder 110.

### Gloss Fixing Unit 80

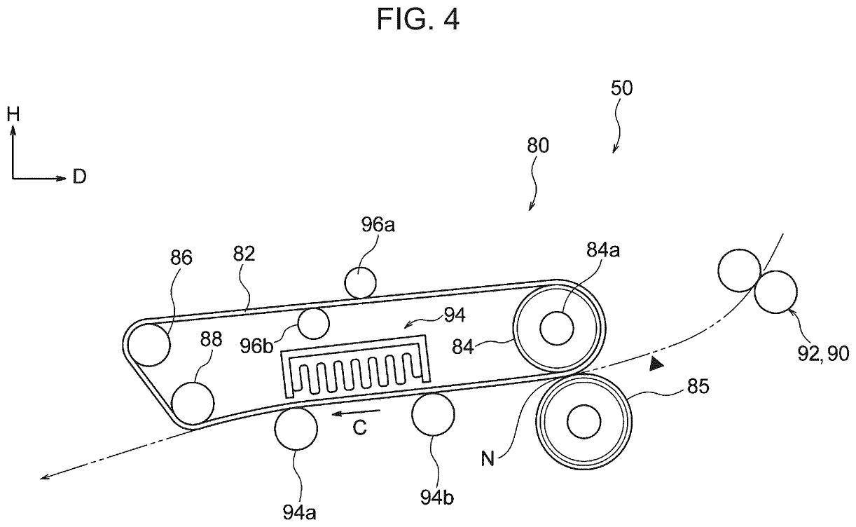

As illustrated in FIG. 4, the gloss fixing unit 80 includes an endless fixing belt 82. The gloss fixing unit 80 also includes a heating roller 84, a separation roller 88, and a control roller 86 for suppressing belt walk, around which the fixing belt 82 is wrapped. The heating roller 84 rotatably supports the fixing belt 82 and has a halogen lamp 84a disposed in a hollow space thereof. The halogen lamp 84a heats a certain region of a nip part N.

The gloss fixing unit 80 also includes a pressing roller 85 that is pressed against the heating roller 84 with the fixing belt 82 disposed therebetween to form the nip part N. The heating roller 84 is rotationally driven by a drive source (not illustrated) to rotate the fixing belt 82 in the direction of arrow C in FIG. 4.

A heat sink 94 is disposed inside the fixing belt 82 to actively cool the recording medium P that is in close contact with the fixing belt 82. The heat sink 94 is cooled by a fan (not illustrated). To bring the transported recording medium P into close contact with the fixing belt 82, urging rollers 94a and 94b that urge the recording medium P against the fixing belt 82 are disposed to face the heat sink 94 with the fixing belt 82 disposed therebetween. In addition, small-diameter tension rollers 96a and 96b that apply a constant tension to the fixing belt 82 are disposed between the control roller 86 and the heating roller 84.

In this structure, the recording medium P transported by the transport unit 90 enters the nip part N. The toner image formed on the recording medium P receives heat and pressure, and is thereby embedded into an image-receiving layer on the recording medium P. This imparts gloss to the toner image on the surface of the recording medium P.

### Output Unit 98

As illustrated in FIG. 1, the output unit 98 is disposed below the gloss fixing unit 80. As illustrated in FIG. 2, the output unit 98 is disposed in front of the gloss fixing unit 80 in the depth direction.

When the maintenance door 51 is opened to expose the inside of the housing 50a, the recording media P that have been output to the output unit 98 can be taken out of the housing 50a.

### Controller 130

The controller 130 controls each unit based on detection results obtained by the detectors 49, 48b, and 126a to 126f illustrated in FIGS. 1, 2, and 3. More specifically, when a paper jam occurs in the post-processing apparatus 50, the controller 130 stops the transport of the recording media P. After the paper jam is cleared, the controller 130 restarts the transport of the recording media P. When a recording medium P remains in the relay transporter 48, the controller 130 causes the remaining recording medium P to be collected by the collecting container 100. The controller 130 is an example of a processor.

### Hardware Structure of Controller 130

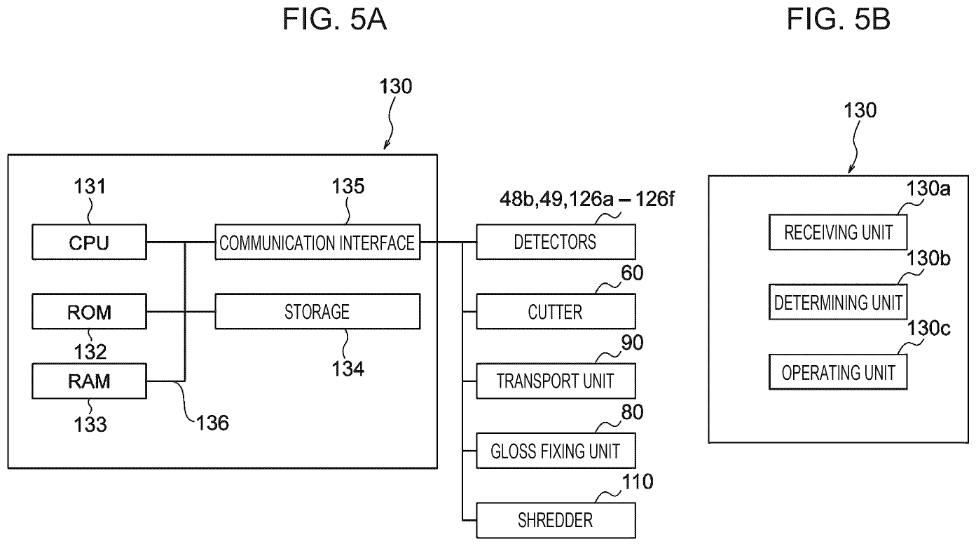

As illustrated in FIG. 5A, the controller 130 includes a central processing unit (CPU) 131 and a read only memory (ROM) 132. The controller 130 also includes a random access memory (RAM) 133, a storage 134, and a communication interface 135. These elements are connected to each other to enable communication therebetween through a bus 136.

The CPU 131, which is a central processing unit, executes various programs and controls each unit. In other words, the CPU 131 reads the programs from the ROM 132 or the storage 134 and executes the programs using the RAM 133 as a work area. The CPU 131 controls the elements and performs various calculation processes in accordance with the programs stored in the ROM 132 or the storage 134.

In the present exemplary embodiment, for example, the controller 130 controls each unit based on the detection results obtained by the detectors 49, 48b, and 126a to 126f.

The ROM 132 or the storage 134 stores an operation table in advance, the operation table showing which units are to be operated and which units are not to be operated based on the detection results obtained by the detectors 49, 48b, and 126a to 126f. A control program determines whether each unit is or is not to be operated based on the operation table.

The RAM 133 serves as a work area and temporarily stores programs or data. The storage 134 is composed of a hard disk drive (HDD) or a solid state drive (SSD), and stores various programs including an operating system and various data.

The communication interface 135 is an interface that enables the controller 130 to communicate with the detectors 48b, 49, and 126a to 126f, the cutter 60, the transport unit 90, the gloss fixing unit 80, the shredder 110, and the like and uses, for example, Ethernet (registered trademark), FDDI, Wi-Fi (registered trademark), or other standards.

When the above-described operation programs are executed, the controller 130 achieves various functions using the above-described hardware resources. The functional configuration of the controller 130 that enables the controller 130 to achieve various functions will now be described.

### Functional Configuration of Controller 130

As illustrated in FIG. 5B, the controller 130 includes a receiving unit 130a, a determining unit 130b, and an operating unit 130c. The functional configuration is achieved when the CPU 131 reads a control program stored in the ROM 132 or the storage 134 and executes the control program. The control of each unit by the controller 130 will be described below together with the operation.

### Operation

The operation of the post-processing apparatus 50 included in the image forming system 160 will now be described. The steps performed in the image forming system 160 are executed when the controller 130 controls each unit.

When the receiving unit 130a of the controller 130 receives an instruction to impart gloss to the surface of the recording medium P, the controller 130 operates the units. More specifically, the operating unit 130c of the controller 130 operates the cutter 60, the transport unit 90, and the gloss fixing unit 80.

Then, the recording medium P supplied from the image forming apparatus 10 illustrated in FIG. 1 through the relay transporter 48 is transported in the width direction by the transport roller 62. More specifically, the detector 126a detects that the leading end of the recording medium P has approached the transport roller 62, for example. Accordingly, the transport roller 70 illustrated in FIG. 3 is set to a contact state in which the transport roller 70 comes into contact with the recording medium P, and the transport roller 72 is set to a separate state in which the transport roller 72 is separated from the recording medium P.

The transport roller 62, the transport roller 66, the transport roller 70, and the first cutters 64 rotate to transport the recording medium P toward the second side in the width direction. When the recording medium P passes the first cutters 64, the edge portions thereof are cut off by the first cutters 64. The edge portions that have been cut off slide downward along a slope (not illustrated) and are collected by the collecting container 100 (see FIG. 2).

After the edge portions are cut off by the first cutters 64, the cutter 60 temporarily stops the transport of the recording medium P at a predetermined position. Then, the transport roller 70 illustrated in FIG. 3 is set to a separated state in which the transport roller 70 is separated from the recording medium P, and the transport roller 72 is set to a contact state in which the transport roller 72 is in contact with the recording medium P. Then, the transport roller 72, the transport roller 76, and the second cutters 74 rotate to transport the recording medium P toward the far side in the depth direction.

When the recording medium P passes the second cutters 74, the edge portions thereof are cut off by the second cutters 74. The edge portions that have been cut off slide downward along a slope (not illustrated) and are collected by the collecting container 100 (see FIG. 2). After the edge portions are cut off by the second cutters 74, the transport unit 90 illustrated in FIG. 2 transports the recording medium P and causes the recording medium P to enter the nip part N in the gloss fixing unit 80.

In the nip part N illustrated in FIG. 4, the toner that forms the toner image is heated to substantially about 120° C. to 150° C. and melted by receiving heat from the halogen lamp 84a and pressure from the pressing roller 85. Accordingly, the toner image is embedded into the image-receiving layer of the recording medium P that is softened by heat. After that, the recording medium P that has passed through the nip part N is transported while being in close contact with the fixing belt 82. While being transported, the recording medium P is actively cooled by the heat sink 94 so that the smoothness of the surface of the fixing belt 82 is transferred to the surface of the recording medium P, that is, to the image-receiving layer, and gloss is imparted to the toner image on the surface of the recording medium P.

When the recording medium P that is transported approaches the separation roller 88, the temperature of the recording medium P has been reduced to or below the melting temperature of the toner (for example, about 40° C. to 80° C.). Then, the recording medium P that has reached the separation roller 88 is separated from the fixing belt 82 due to the stiffness (rigidity) of the recording medium P itself. The recording medium P separated from the fixing belt 82 is output to the output unit 98 illustrated in FIG. 2. In the present exemplary embodiment, the post-processing performed by the post-processing apparatus 50 is the process of cutting the edge portions of the recording medium P with the cutter 60 and imparting gloss to the toner image on the surface of the recording medium P.

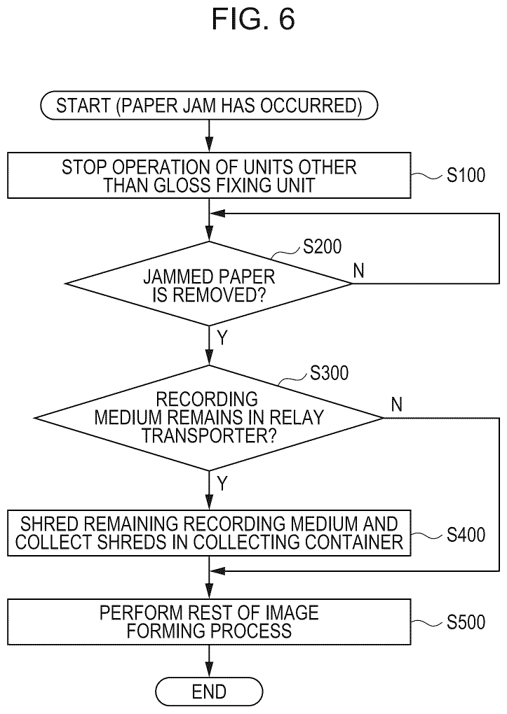

A procedure performed when a paper jam occurs in the post-processing apparatus 50 will be described with reference to the flowchart of FIG. 6.

The receiving unit 130a of the controller 130 receives the detection results obtained by the detectors 49, 48b, and 126a to 126f. When the determining unit 130b determines that a paper jam has occurred in the post-processing apparatus 50 based on the detection results received by the receiving unit 130a, the procedure proceeds to step S100 illustrated in FIG. 6.

More specifically, the determining unit 130b determines that a paper jam has occurred in the post-processing apparatus 50 in the following cases. That is, a paper jam is determined to have occurred when, for example, a recording medium P remains detected by the detectors 49, 48b, and 126a to 126f for a period equal to or longer than a predetermined time, or when a recording medium P being transported that is expected to be detected is not detected by the detectors 49, 48b, and 126a to 126f.

In step S100, the operating unit 130c of the controller 130 stops the operation of the units other than the gloss fixing unit 80. In the present exemplary embodiment, no paper jam occurs in the gloss fixing unit 80. Therefore, when there is a recording medium P that has reached the gloss fixing unit 80 at the time of occurrence of the paper jam, the gloss fixing unit 80 is caused to impart gloss to the toner image, and then the recording medium P is output to the output unit 98. Thus, the operation of the gloss fixing unit 80 is stopped after a predetermined time since the stoppage of the operation of other units.

In addition, a user interface (UI) (not illustrated) presents a display indicating that a paper jam has occurred. When an operator sees the display, the operator opens the maintenance door 51 or 52, for example, and removes the paper that has caused the paper jam (hereinafter referred to as “jammed paper”). After the jammed paper is removed, the operator closes the maintenance door 51 or 52.

In step S200, the determining unit 130b of the controller 130 determines whether the jammed paper is removed based on the detection results obtained by the detectors 126a to 126f. In other words, the determining unit 130b of the controller 130 determines whether the paper jam is cleared based on the detection results obtained by the detectors 126a to 126f. When the jammed paper is removed, the procedure proceeds to step S300. When the jammed paper is not removed, the determination is repeated in step S200. In other words, the determination in step S200 is repeated until the operator removes the jammed paper.

In step S300, the determining unit 130b of the controller 130 determines whether a recording medium P remains in the relay transporter 48 based on the detection results obtained by the detectors 49, 48b, and 126a to 126f. In other words, when the paper jam is cleared and the transport of the recording media P is restarted to perform post-processing on the recording media P, the determining unit 130b of the controller 130 determines whether a recording medium P remains in the relay transporter 48. When a recording medium P remains in the relay transporter 48, the procedure proceeds to step S400. When no recording medium P remains in the relay transporter 48, the procedure proceeds to step S500.

When the transport of a recording medium P is stopped before the recording medium P is processed by the gloss fixing unit 80, the image quality of the recording medium P is degraded. In other words, when the transport of the recording medium P is stopped before the post-processing by the post-processing apparatus 50 is completed, the image quality of the recording medium P is degraded. In still other words, the image quality of the remaining recording medium P that remains in the relay transporter 48 is degraded.

In step S400, the operating unit 130c of the controller 130 causes the remaining recording medium P that remains in the relay transporter 48 to be shredded and collected by the collecting container 100. In other words, if a remaining recording medium P is present in the relay transporter 48 when the paper jam is cleared and the transport of the recording media P is restarted to perform post-processing on the recording media P, the remaining recording medium P is caused to be collected by the collecting container 100.

More specifically, the operating unit 130c operates the transport rollers 48a, the transport roller 62, the transport roller 66, the transport roller 70, and the shredder 110 illustrated in FIG. 1. Thus, the transport rollers 48a, the transport roller 62, the transport roller 66, the transport roller 70, and the first cutters 64 rotate, and the remaining recording medium P is transported toward the second side in the width direction. Then, the transport roller 70 delivers the remaining recording medium P to the transport roller 114 of the shredder 110 without changing the transport direction of the remaining recording medium P.

Then, the transport roller 114 transports the remaining recording medium P. The remaining recording medium P comes into contact with the guide surface 116a of the guide member 116. The guide surface 116a changes the transport direction of the remaining recording medium P transported by the transport roller 114 and guides the remaining recording medium P toward the shredding blade section 118. Then, the blade units 118a and 118b rotate and transport the remaining recording medium P while shredding the remaining recording medium P. The shreds of the remaining recording medium P are collected by the collecting container 100.

Thus, the operating unit 130c causes the remaining recording medium P to be transported through the cutter 60, and then be collected by the collecting container 100 by changing the transport direction of the remaining recording medium P. After the shreds of the remaining recording medium P are collected by the collecting container 100, the operating unit 130c stops the operation of the transport rollers 48a, the transport roller 66, the transport roller 70, and the shredder 110.

In step S500, the operating unit 130c of the controller 130 operates the cutter 60, the transport unit 90, and the gloss fixing unit 80. In other words, the operating unit 130c of the controller 130 restarts the transport of the recording media P to perform post-processing on the recording media P. Then, the operating unit 130c performs the rest of the image forming process, and ends the procedure when the entire image forming operation is completed.

### SUMMARY

As described above, according to the image forming system 160, when a paper jam occurs in the post-processing apparatus 50, the controller 130 causes the remaining recording medium P that remains in the relay transporter 48 to be collected by the collecting container 100.

In addition, according to the image forming system 160, the controller 130 causes the remaining recording medium P to be shredded by the shredder 110 before being collected by the collecting container 100.

In addition, according to the image forming system 160, the shredder 110 is capable of shredding a recording medium P fed from the outside of the housing 50a through the opening door 54.

In addition, according to the image forming system 160, the edge portions of the recording medium P cut off by the cutter 60 and the remaining recording medium P that has remained in the relay transporter 48 are collected by the collecting container 100.

In addition, according to the image forming system 160, the operating unit 130c of the controller 130 causes the remaining recording medium P to be transported through the cutter 60 and then be collected by the collecting container 100 by changing the transport direction of the remaining recording medium P.

Although a specific exemplary embodiment of the present disclosure has been described in detail, the present disclosure is not limited to the exemplary embodiment, and it is obvious to those skilled in the art that the present disclosure covers various other exemplary embodiments within the scope of the present disclosure. For example, in the above-described exemplary embodiment, the remaining recording medium P that has remained in the relay transporter 48 is shredded before being collected by the collecting container 100. However, the remaining recording medium P may be collected by a collecting container without being shredded. In this case, the effects obtained by shredding the remaining recording medium P are not obtained.

In addition, although the housing 50a includes the opening door 54 in the above-described exemplary embodiment, the opening door may be omitted. In this case, the effects obtained by the opening door 54 are not obtained.

In addition, in the above-described exemplary embodiment, when a paper jam occurs in the post-processing apparatus 50, the operating unit 130c stops the operation of the units other than the gloss fixing unit 80. However, if a paper jam may occur in the gloss fixing unit 80, the operation of the gloss fixing unit 80 may also be stopped.

In addition, although it is not described above in the exemplary embodiment, edge portions of the remaining recording medium P may be cut off by the first cutters 64 when the remaining recording medium P passes through the cutter 60.

In addition, although the image forming apparatus 10 uses an electrophotographic system in the above-described exemplary embodiment, inkjet or other systems may also be used.

In addition, although post-processing is performed on paper serving as the recording medium P in the above-described exemplary embodiment, post-processing may be performed on a resin sheet or the like serving as the recording medium P.

In addition, although it is not described above in the exemplary embodiment, the image forming system 160 may be composed of either a single apparatus or plural apparatuses. In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image forming system including:
an image forming apparatus that forms an image on a recording medium;
a relay transporter that transports the recording medium on which the image is formed by the image forming apparatus;
a post-processing apparatus including a collecting container that collects a recording medium, the post-processing apparatus performing post-processing on the recording medium transported by the relay transporter; and
at least one processor configured to:
   stop transport of a recording medium when a paper jam occurs in the post-processing apparatus; and
   if a remaining recording medium is present in the relay transporter when the paper jam is cleared and the transport of the recording medium is restarted, cause the remaining recording medium to be collected by the collecting container.
      (((2)))

The image forming system according to (((1))),
wherein the post-processing apparatus includes a shredder that shreds a recording medium, and
wherein the processor is configured to cause the remaining recording medium to be shredded by the shredder before being collected by the collecting container.
   (((3)))

The image forming system according to (((2))),
wherein the post-processing apparatus includes a housing including an opening part that opens to expose the shredder to outside, and
wherein the shredder is capable of shredding a recording medium inserted into the housing from the outside through the opening part.
   (((4)))

The image forming system according to any one of (((1))) to (((3))),
wherein the post-processing apparatus includes a cutter that cuts off edge portions of a recording medium, and
wherein the edge portions cut off by the cutter are collected by the collecting container.
   (((5)))

The image forming system according to (((4))),
wherein the collecting container is disposed below the cutter, and
wherein the processor is configured to cause the remaining recording medium to be transported through the cutter and then be collected by the collecting container by changing a transport direction of the remaining recording medium.

What is claimed is:

1. An image forming system comprising:
an image forming apparatus that forms an image on a recording medium;
a relay transporter that transports the recording medium on which the image is formed by the image forming apparatus;
a post-processing apparatus including a collecting container that collects a recording medium, the post-processing apparatus performing post-processing on the recording medium transported by the relay transporter; and
at least one processor configured to:
stop transport of a recording medium when a paper jam occurs in the post-processing apparatus; and
if a remaining recording medium is present in the relay transporter when the paper jam is cleared and the transport of the recording medium is restarted, cause the remaining recording medium to be collected by the collecting container.

2. The image forming system according to claim 1,
wherein the post-processing apparatus includes a shredder that shreds a recording medium, and
wherein the processor is configured to cause the remaining recording medium to be shredded by the shredder before being collected by the collecting container.

3. The image forming system according to claim 2,
wherein the post-processing apparatus includes a housing including an opening part that opens to expose the shredder to outside, and
wherein the shredder is capable of shredding a recording medium inserted into the housing from the outside through the opening part.

4. The image forming system according to claim 1,
wherein the post-processing apparatus includes a cutter that cuts off edge portions of a recording medium, and
wherein the edge portions cut off by the cutter are collected by the collecting container.

5. The image forming system according to claim 4,
wherein the collecting container is disposed below the cutter, and
wherein the processor is configured to cause the remaining recording medium to be transported through the cutter and then be collected by the collecting container by changing a transport direction of the remaining recording medium.

6. An image forming system comprising:
image forming means for forming an image on a recording medium;
relay transport means for transporting the recording medium on which the image is formed by the image forming means;
post-processing means, including a collecting container that collects a recording medium, for performing post-processing on the recording medium transported by the relay transport means;
means for stopping transport of a recording medium when a paper jam occurs in the post-processing means; and
means for, if a remaining recording medium is present in the relay transport means when the paper jam is cleared and the transport of the recording medium is restarted, causing the remaining recording medium to be collected by the collecting container.
